(19) United States
(12) Patent Application Publication
(10) Pub. No.: US 2006/0072491 A1
(43) Pub. Date: Apr. 6, 2006

(54) Robust communication system

(75) Inventor: Paul R Simons, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/535,290

(22) PCT Filed: Nov. 7, 2003
(86) PCT No.: PCT/IB03/05021

§ 371 Date: May 17, 2005

(30) Foreign Application Priority Data
Nov. 22, 2002 (GB) 0227287.0

(51) Int. Cl. H04Q 7/00

(52) U.S. Cl. 370/328

(57) ABSTRACT

A primary station (10) for use in a communication system is described, the system operating according to a predetermined protocol. The primary station is capable of managing a plurality of piconets having secondary stations (12a, b, c) which communicate with the primary station on individual logical radio channels. In particular, the capacity available on the channels is monitored (20,25) and the channels in use controlled thereby enabling the secondary stations to communicate even in periods of heavy use. The primary station is suitable for application as a wireless access point in public spaces (airports, train stations) and in business or home scenarios where robust low power multiple radio networks are required.

The present invention relates to a communication system and further relates to a primary station for use in such a system and to a method of operating such a system. The present invention has particular, but not exclusive, application to a wireless access point incorporating a ZigBee™ short range communication system.

In recent years there has been increasing interest in enabling devices to interact via wireless communication links, thereby avoiding the need for extensive cabling. An example of a communication system which may be used for such wireless links is a ZigBee network, operating according to a specification defined by the ZigBee Alliance (www.zigbee.com). It is envisaged that such a network will provide very low-cost, short range radio links between mobile computers (PDA, Laptop), mobile phones, lighting and other devices in the home/office. Other applications of such networks in public spaces such as shopping malls and airports are commonly envisaged in which a user is provided with information (e.g. special offers, flight gate number, delays etc . . . ) on their mobile phone/PDA in the vicinity of, for example a dedicated information terminal or station incorporating a wireless access point.

In such an airport application, there may be many users wishing to obtain information at the same time, particularly for example when unpredicted events such as air traffic control problems occur. The finite resources of the communication system, in terms of capacity of the single radio channel used together with radio message traffic load due to the number of registered devices/users allowed to connect at one time may thus be put under strain, leading to system collapse and/or user frustration.

A system is described in International patent application WO 01/65864, wherein a method and apparatus for assisting a user to find a communication resource of sufficient capacity is described. The method involves providing a user with location information of a station having available resource, so that the user is assisted in finding a fixed communication station having sufficient capacity for handling a desired communication. This has the drawback that many stations physically separated but interconnected are required, and further burdens the user, having found a station, with the inconvenience of moving to another.

It is therefore an object of the present invention to provide a robust communication system whereby a user is able to obtain information despite heavy user demand.

According to a first aspect of the present invention there is provided a communication system comprising a primary station and a plurality of secondary stations, wherein the primary station has means for exchanging radio messages with the secondary stations over a number of radio channels in accordance with a predetermined protocol, means for monitoring the capacity of said channels and means for controlling the channel used by at least one enquiring secondary station at least in part in dependence on said monitored capacity.

According to a second aspect of the present invention there is provided a primary station for use in a communications system comprising a plurality of secondary stations, wherein the primary station has means for exchanging radio messages with the secondary stations over a number of radio channels in accordance with a predetermined protocol, means for monitoring the capacity of said channels and means for controlling the channel used by at least one enquiring secondary station at least in part in dependence on said monitored capacity.

According to a third aspect of the present invention there is provided a method of operating a communication system comprising a primary station and a plurality of secondary stations, the method comprising the primary station exchanging radio messages with the secondary stations over a number of radio channels in accordance with a predetermined protocol, monitoring the capacity of said channels; and controlling the channel used by at least one enquiring secondary station at least in part in dependence on said monitored capacity.

Further aspects of the present invention provide a computer program for operating the primary station.

The system, station and method aspects of the present invention provide information to a user in situations where radio channels being used are experiencing heavy data traffic loads by monitoring the capacity of the channels available and automatically controlling the channel with which a user's device incorporating a secondary station communicates. Robust communication at a single primary station is therefore provided.

In a preferred embodiment a wireless access point incorporating a primary station operates according to the ZigBee™ Alliance Radio Standard, and a user device is automatically registered with the primary station to obtain information. The system may then, should the system experience problems in servicing the user device due to other users on the system (heavy load), or due to radio channel interference for example, automatically de-register the device and allow re-registration on a channel having capacity since few (or zero) registered stations are using that channel. Channels which have little capacity (for example many users, or a few users requiring lots of capacity) are blocked from allowing users to register.

The primary station advantageously operates in beaconing mode, wherein beacon signals are transmitted on each radio channel, and wherein the capacity of each channel is monitored by monitoring the number of time slots available per superframe time for that channel. In this mode, secondary stations requiring guaranteed time slots may be allocated channels determined to have such capacity.

The primary station advantageously comprises a communication module having transceiver means for each radio channel. The module is linked to processing means which monitors and controls the transceivers as described above. The processing means may be located within the primary station for compact, single box solutions, or a computer located remote to the primary station may provide the monitoring and control functionality.

Hence, a communication system supporting a predefined protocol which dictates communication on a single channel is enabled to provide services to a plurality of users over different channels in varying traffic load conditions.

Embodiments of the present invention will now be described, by way of example, and with reference to the accompanying drawings wherein:

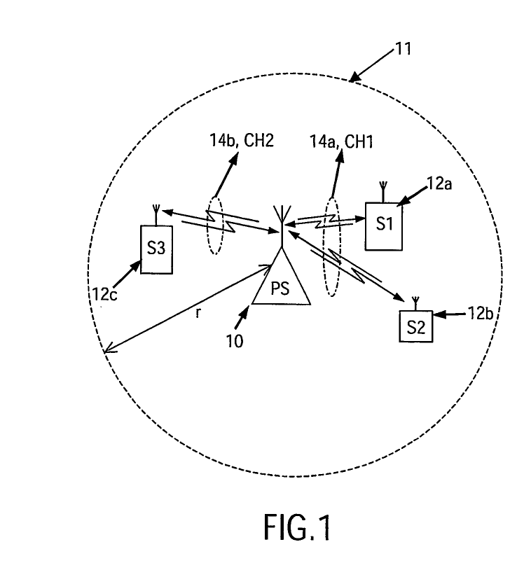

FIG. 1 is a diagram of a communication system,

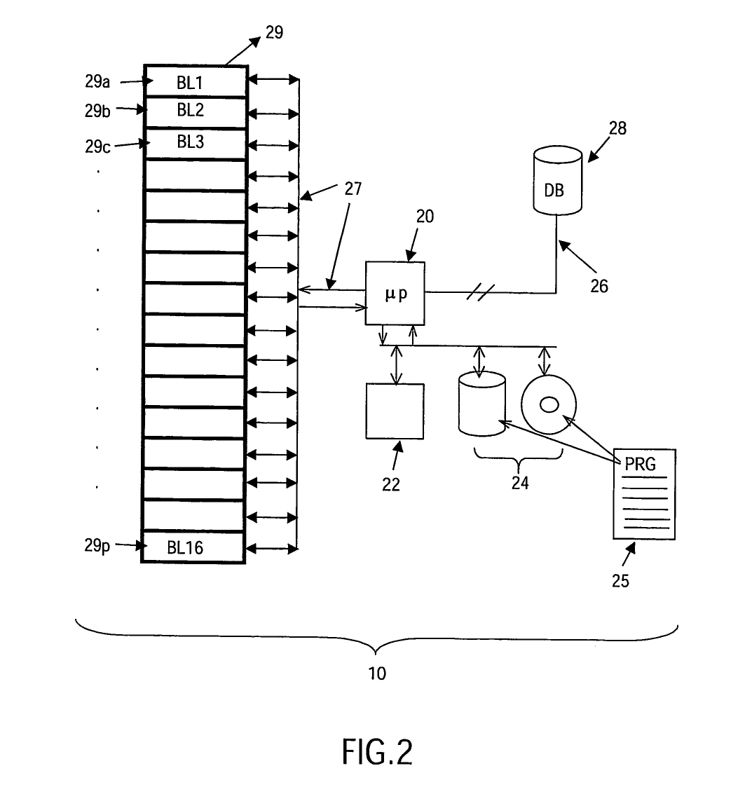

FIG. 2 is a schematic diagram of a primary station having radio channel blocks,

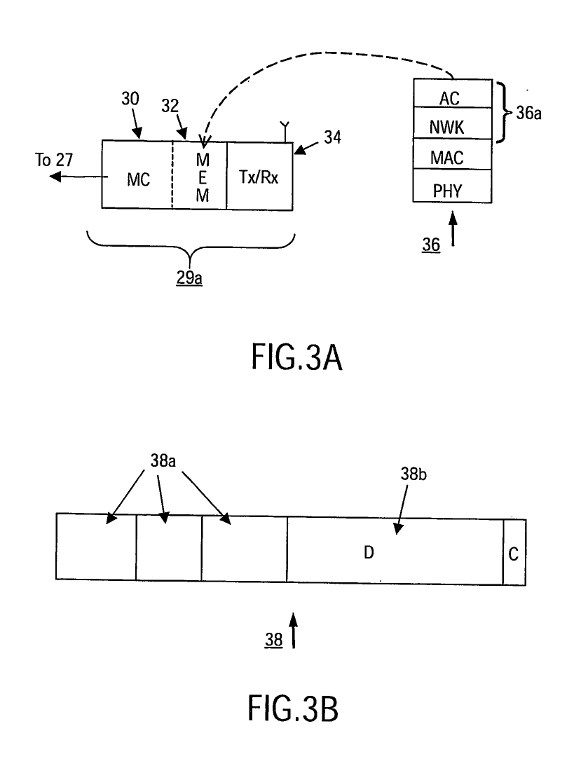

FIG. 3A illustrates a radio channel block and a radio protocol stack,

FIG. 3B is a diagram of a typical radio message,

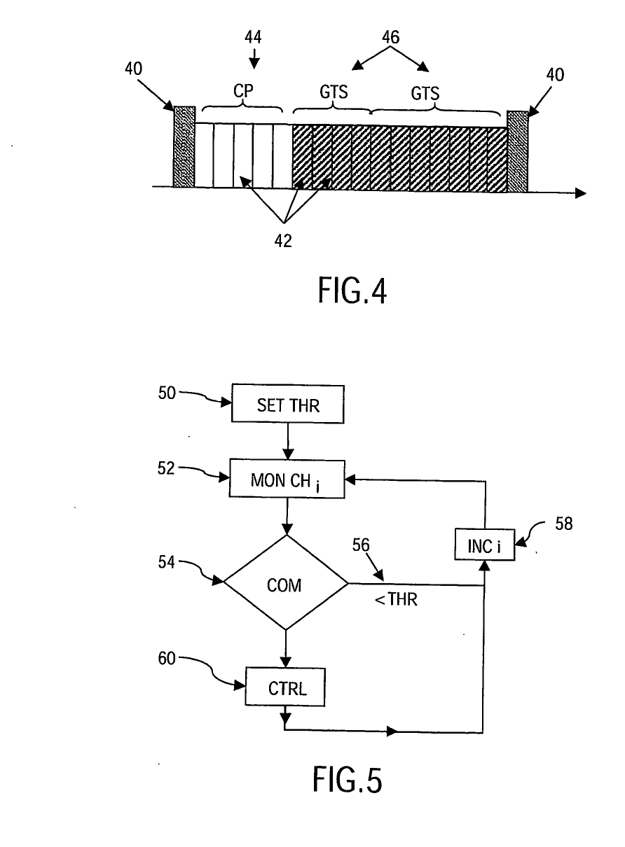

FIG. 4 is a diagram of a beacon superframe, and

FIG. 5 is a flowchart illustrating a method of operating a primary station in accordance with the present invention.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments.

In the following we consider particularly a communication system which utilises the ZigBee low power short range protocol for communication of messages between stations. The system is also described with reference to an airport scenario in which users require flight information. As will be recognised, other radio protocol and systems may also be employed and in differing scenarios (for example theme parks, shopping malls, cinemas, theatres, bus and train stations, home or office networks) in which it is advantageous to simultaneously offer and manage more than one radio channel/piconet at the same location.

An embodiment will now be described that operates according to the ZigBee Alliance radio protocol (www.zigbee.com). The Alliance is, at the time of making this application working with the IEEE™ to standardise the protocol as IEEE 802.15.4. The protocol provides for a single personal area network (PAN) coordinator device to handle up to 255 devices on its network, the network communicating on a single radio channel using a direct spread spectrum sequencing (DSSS) scheme and wherein the radio channel is chosen from one of 16 predefined channels in the unlicensed ISM band at 2.4 GHz. The network may operate in a peer-to-peer mode in which radio messages are exchanged according to polling requests. Alternatively, the network may operate in a so-called star topology in which a central master co-ordinates all communication on its network (this configuration is also sometimes called by those skilled in the art a “master/slave” configuration). The maximum quoted network data-rate is around 250 kbits/s, this being shared between all devices on the network.

Allowing for real world noise and interference problems, applicants estimate that a more realistic payload data rate will be around 100 kbits/s. The devices operate via a protocol layered stack having lower physical (PHY) and Medium Access Control layers (MAC) and Higher Layers (HL). The higher layers comprise the network (NWK) layer and application code (AC) for example which generates and formats payload data for insertion in radio messages. Conceptually the messages pass down (or up) through the layers with each layer operating on or adding header field data for the next layer as is well known to those skilled in the art. Eventually the messages are transmitted in packet form to the air interface for reception by the intended recipient device.

One master/slave or star mode in which a ZigBee network operates in accordance with the protocol is that of “beaconing” data on a selected single radio channel, wherein a network coordinator sends out a periodic reference or beacon signal on a single radio channel which secondary stations (user devices) receive and react to. The reference beacon contains indications (e.g. unique ID's) of those secondary stations for which data is intended or pending, with the secondary stations responding in accordance with a multiple access protocol. All devices operating either on a star topology or a peer-to-peer topology have a unique 64 bit extended address. This address can be used for direct communication within the PAN or can be mapped to a short address allocated by the PAN coordinator when a device associates to the network.

The PAN identifier is chosen so as not to conflict with any other identifier currently being used by any other network within the radio sphere of influence. Once a PAN ID is chosen the PAN co-ordinator can allow other devices to join the network. Communication of packets is generally acknowledged (ACK) in ZigBee to confirm reception of a transmitted data packet.

Other features of ZigBee include a carrier sense multiple access (CSMA) algorithm by which a device checks that the radio frequency channel is free before transmitting. However, this does not avoid clashes resulting from a second device checking the frequency channel during the brief interval that a first device is preparing to transmit following checking that the frequency channel is free. A contention resolution scheme, such as a random exponential back off scheme is preferably employed to try and avoid the first and second devices from retrying at the same instant.

The ZigBee scheme provides basic registration or enumeration processes wherein a secondary station wishing to join a piconet scans for beacons. (An example of a registration process is described in applicant's co-pending international application WO0128157 published 25 Oct. 2001, incorporated herein by reference and to which the reader is now directed). Upon detecting a beacon it may then request registration in which network and device ID's are exchanged (ZigBee defines 64 bit unique identifiers for a device, although in use it is preferable for a coordinator to allocate a device a shorter 16 or 8 bit radio code/identifier). The coordinator stores a routing table of these allocated codes for messaging. Following registration the device is able to exchange radio messages with the coordinator, whilst ignoring messages from other networks or other devices on its network via the ID's representing source/destination/network addresses in header fields of the radio messages.

FIG. 1 illustrates a system having a primary station 10 (PS) operable to communicate over a finite radio range (represented by the dashed circle 11 and radius r in the Figure) with a number of secondary stations 12a (S1), 12b (S2) and 12c (S3). In the Figure S1 and S2 are communicating wirelessly with the PS using a first radio channel (CH1) and the station S3 is communicating via a second radio channel (CH2). The PS and S1, S2 effectively form a first network (or piconet), whilst the PS and device S3 form a second network (or piconet). In this embodiment concerning an airport scenario the stations represented by S1, S2 and S3 would typically represent users portable devices such as mobile phones, handheld computers (PDA's) and laptops which are provided with standard ZigBee radio modules. However, the stations are not limited to mobile devices as is readily apparent if one considers a home networking scenario in which the stations may represent ZigBee equipped devices such as lamp switches, lamps, thermistors, DVD players, remote control units and TV sets for example.

FIG. 2 is a block diagram of the primary station 10 which comprises a microprocessor 20 (μp) coupled to volatile memory 22 and non volatile storage 24 (which may for example comprise optical compact disc and/or magnetic hard disk drives). The processor also has a link 26 (which may be via a local area network (LAN), or the internet for example) to a database 28 (DB) which stores information (e.g. flight departure gate, flight delay) that may be supplied to a users device 12a,b,c. The microprocessor 20 is further coupled 27 to a communications module 29. The coupling 27 to the communications module may be via for example a Universal Serial Bus (USB) hub (not shown) in the case where a conventional PC is used to provide the microprocessor and storage, or it may be via a dedicated data bus (as shown in this embodiment) for a fully integrated single box solution.

The communications module comprises in this embodiment sixteen blocks 29a, 29b, 29c . . . 29p, one for each channel available in the ZigBee scheme at 2.4 GHz. Each block comprises a microcontroller and a transceiver which together perform the function of a ZigBee piconet master or co-ordinator device, each coordinating the transmission and reception of radio messages with secondary stations which belong to that block's piconet.

A computer program (PRG) 25 stored in the non volatile storage 24 is provided, the program comprising instructions which when loaded to memory 22 direct the microprocessor 20 to monitor the capacity of the radio channels via the data bus 27 and control which radio channel a secondary station uses (as will be described in more detail below).

FIG. 3A diagrammatically shows a typical example of one of the blocks 29a of the module 29. The block 29a comprises a microcontroller 30 coupled to a transceiver 34. The block comprises protocol and application memory 32 (which in this embodiment is shown provided separately but may be embedded within the microcontroller depending on the application requirements) for storing the ZigBee radio protocol stack 36. The lower layers of the stack comprise a Physical layer (PHY) and a Medium Access Control (MAC) layer through which a received radio message 34 is passed to the upper network (NWK) and application code (AC) layers 36a.

FIG. 3B shows an example structure of a radio header/payload data packet or message 38. The message has various fields 38a containing header information (for example a senders unique identifier which is typically in ZigBee an 8-byte unique number indicating device manufacturer and the device/secondary station). Application data 38b and checksum (C) fields are also provided. As well known to those skilled in the art of packet radio systems, portions of the message (service and protocol data units SDU, PDU) are operated on, and of relevance to, the various layers defined in the radio standard. The memory 32 also stores a routing table in which the radio identities of members of the block's piconet are maintained.

It is to be noted that the primary station 10 of FIG. 1 and FIG. 2 in this embodiment provides hardware which is capable of operating as a complex access point in which up to sixteen ZigBee piconets may be operated simultaneously in the same location, each piconet operating on a separate radio channel. Furthermore, the microprocessor 20 is able to obtain information about each piconet from the block(s), and in particular is able to monitor the number of members of each piconet, and which radio channels are in use.

In this embodiment the blocks 29a and 29b are operating in the aforementioned beacon mode. With reference to FIG. 4, the beacon signals 40 are separated by a superframe time, conveniently split into sixteen equally sized time slots 42. The beacon signal is transmitted in the first slot of each superframe and the time between beacon signals is typically 15 ms.

A portion of this time 44 comprises a contention period (CP) in which secondary stations compete for the channel via the CSMA/CA mechanism and the ZigBee standard further allows the remaining portion of the frame to be guaranteed to particular devices. Hence, in this mode devices compete for channel access and if granted may request and be allocated guaranteed time slots 46 (GTS). It is typical to allow up to seven devices to have guaranteed time slots during a frame.

If a single device requests a guaranteed time slot occupying most of the frame, other devices attempting to access the channel have little time (a few slots 42) to send packets of data in radio messages. In effect, the bandwidth available to any single device is reduced. Therefore, the data throughput rate experienced by a secondary station depends upon the device gaining access in the contention period, and subsequently on how much guaranteed time is available, and how much data is required to be transmitted/received.

Applicants have realised that an airport wireless access point or similar scenario which involves many people requiring information at the same/similar time from a network co-ordinator may only be able to realistically service a few devices requesting guaranteed time slots at a time, and will not prove robust in busy times when many users are requesting information.

A busy network may occur when, for example 3 different users make a request for a 10 kbyte (80 kbits) data file at the same time. For a prior art single channel primary station coordinator having a capacity of about 100 kbits/s it would take at least 2.4 seconds to deliver the 240 kbits of data requested. For a multi-channel co-ordinator constructed in accordance with the present invention (and for this example having at least 3 channel blocks 29a, 29b, 29c) the user devices could be registered on different channels allowing the data to be transferred simultaneously within a second.

Similar capacity problems are anticipated to exist with any inexpensive, low power radio protocol which may be ubiquitous in a wide range of devices due to cost, but which only enables communication on a single channel at the same time.

Methods for Operating the System

In one example way of operating the system embodying the method of the invention the microprocessor monitors the number of secondary stations registered with each block and instructs those having a number of secondary stations greater or equal to a predetermined threshold number to refuse registration requests from new enquiring secondary stations. In applications where small amounts of data are expected on average to be exchanged between many users and the primary station it is advantageous to set the threshold relatively high. For example, each channel allows up to 255 user devices to connect, so that one may set the threshold at say 5 users per channel. This enables 80 users to connect to the PS at one time whilst guaranteeing each device a significant proportion of bandwidth (a fifth of channel capacity per device on average, compared with one eightieth of channel capacity if 80 users are connected to a single primary station co-ordinator operating on a single channel as in a conventional system). This is achieved by the computer program 25 and application code of each block 29a, 29b . . . 29p passing relevant data via the bus 27. For example, the microprocessor 20 monitors the number of registered devices per block by obtaining relevant data in the form of a list of station ID's from the microcontroller table (which is provided via the application code).

When the block is “full”, in that the number of secondary stations registered with that block is equal to or greater than the threshold, then the application code of that block receives a command to prevent future requests for registration. This can be controlled by the application layer of the block instructing the MAC layer to alter the PAN Information Base (PIB). The block is responsible for maintaining the PIB to keep a database of managed objects. If the block sets the macAssociatePermit flag (as defined in ZigBee) for a secondary device to false any request to subsequently join a network by that device will be refused.

Following this, any requests from a secondary station to join the piconet will be denied, whilst other blocks with more capacity will be available to accept the request.

Once a user disassociates/deregisters his device from the piconet (by for example simply carrying his device out of range r, from the wireless access point 10) then the blocking command is reset and the block is free to accept new registrations.

Alternatively, the threshold number may be dynamically adjusted according to various factors which may be statistically determined during the use of the primary station to include factors such as average and peak data rate. In a train station or shopping mall scenario it will be possible to determine busy (rush hour/lunch hour) and quiet periods during the day, and dynamically adjust the threshold accordingly.

The main steps of the above are illustrated in FIG. 5, wherein the computer program 25 instructs the processor 20 to:

Set a threshold per piconet 50 (SET THR) following which a channel CHᵢ is monitored 52 wherein the number of secondary stations using that piconet is returned to the processor 20, and then in comparison step 54 (COM) compare that number with the threshold and if,
the result is less than the threshold, branch 56 is followed to step 58 where the next channel is selected (INC i) and the program loops back to the monitoring step 52 and continues,
else
the program, determining that the number of secondary stations using that piconet is equal to or greater than the threshold executes control step 60 (CTRL) in which the block 29a using that channel is instructed to block further registrations, and then loops back to the monitoring step 52 and continues.

In another related method, the threshold is set initially to one (i.e. one device per channel), and therefore each block would accept only one registration before being instructed to not accept further requests. When all sixteen (in this embodiment) blocks have one registered user then the computer program increments the threshold. Hence, each channel is used sequentially with respect to the arrival of enquiring users. In this example, the first sixteen devices may be allocated all available timeslots between beacons. Once a seventeenth device requests registration then that block accepting the request will have to share the available slots (and hence bandwidth) with the other device on its piconet. This method has the advantage that users requiring large amounts of information may be accommodated (for example a user with a laptop at the airport may be delayed, and may wish to pass time by playing a game offered by the wireless access point, the game requiring low latency connections and hence guaranteed time slots GTS).

The above methods may further be combined with the following method, wherein a user preferably requiring large GTS periods may be dynamically re-assigned a channel/piconet which is less busy than the piconet the user is currently participating in. This is achieved by sending a disassociation notification command (a ZigBee command that effectively kicks a station off a network/piconet) to the secondary station, and to re-register the station with a block that has few, or no users (the block determined in the monitor step 52).

In an alternative embodiment, two or more users having high capacity requirements (perhaps to exchange video clips or personal files) exchange data via the primary station which acts as a bridge between the networks/channels to which the secondary stations are associated.

In the foregoing a system employing a primary station is described, the system operating according to methods wherein the activity and requirement of connected devices is monitored, and the channels available for connection are managed in accordance with the monitored dynamic use. The system has a communication module capable of communicating according to a specified radio protocol.

The communication module may have a different number of blocks depending upon the protocol and application scenario for which it is designed. For example, a home network primary station may comprise three blocks on which a lighting, heating and consumer electronic appliance piconet are operated, each operating on a separate channel respectively.

Alternatively, the communication module may comprise a single transceiver architecture with a single receiver and multiple transmitters, the single complex transceiver being directly controlled by the microprocessor and operating the methods as hereinbefore described.

Furthermore, although the embodiments have been described with reference to the ZigBee radio protocol, the methods and apparatus of the present invention may also have application in other radio protocols wherein a network or piconet operates on one of a number of logical radio channels and wherein capacity may be limited in periods of heavy use. Bluetooth™ is an example of such a radio protocol in existence at the time of writing.

In the above a primary station for use in a communication system is described, the system operating in compliance with a predetermined protocol. The primary station is capable of managing a plurality of piconets having secondary stations which communicate with the primary station on individual logical radio channels. In particular, the capacity available on the channels is monitored and the channels in use controlled thereby enabling the secondary stations to communicate even in periods of heavy use. The primary station is suitable for application as a wireless access point in public spaces (airports, train stations) and in business or home scenarios where robust low power multiple radio networks are required.

From reading the present disclosure, other modifications will be apparent to persons skilled in the art. Such modifications may involve other features which are already known in the design, manufacture and use of radio communication systems and component parts thereof and which may be used instead of or in addition to features already described herein without departing from the spirit and scope of the present invention.

1. A method of operating a communication system comprising a primary station (10) and a plurality of secondary stations (12a,12b,12c), the method comprising:
the primary station (10) exchanging radio messages (38) with the secondary stations over a number of radio channels (14a,14b) in accordance with a predetermined protocol (36),
monitoring the capacity of said channels; and
controlling the channel used by at least one enquiring secondary station (12a) at least in part in dependence on said monitored capacity.

2. A method according to claim 1, wherein the monitoring of channel capacity comprises:
comparing the number of secondary stations (12a,12b,12c) registered per channel (14a,14b) against a predetermined threshold, and
blocking registration for those channels having a number of secondary stations registered per channel equal to or above the predetermined threshold.

3. A method according to claim 2, wherein the monitored channel (14b) having the lowest number of registered secondary stations (12c) is used to register an enquiring secondary station.

4. A method according to claim 1, wherein beacon signals (40) are transmitted on each radio channel (14a,14b), and wherein the capacity of each channel is monitored by monitoring the number of time slots (42) available per frame time for that channel.

5. A method according to claim 4, wherein the enquiring secondary station requesting guaranteed time slots (46) is allocated a radio channel having available unused timeslots for said request.

6. A communication system comprising a primary station (10) and a plurality of secondary stations (12a,12b,12c), wherein the primary station (10) has means (29) for exchanging radio messages (38) with the secondary stations over a number of radio channels in accordance with a predetermined protocol, means (20,27) for monitoring the capacity of said channels and means (20,25,27) for controlling the channel used by at least one enquiring secondary station at least in part in dependence on said monitored capacity.

7. A primary station (10) for use in a communications system comprising a plurality of secondary stations, wherein the primary station has means (29) for exchanging radio messages (38) with the secondary stations over a number of radio channels in accordance with a predetermined protocol, means (20,27) for monitoring the capacity of said channels and means (20,25,27) for controlling the channel used by at least one enquiring secondary station at least in part in dependence on said monitored capacity.

8. A primary station as claimed in claim 7, wherein the means for exchanging radio messages comprises a communication module (29) having a plurality of transceivers (29a,29b,29c) coupled (35,27) to said monitoring and control means (20), and wherein each transceiver operates a single radio channel.

9. A primary station as claimed in claim 7 or claim 8, wherein the monitoring means (20) monitors the available timeslots (42) between periodic beacon signals (40) transmitted by transceivers on respective channels, and wherein the control means (20) allocates a radio channel having available unused timeslots to the at least one enquiring secondary station.

10. A primary station (10) as claimed in claim 7, wherein the predetermined protocol is the ZigBee radio protocol.

11. A computer program (25) comprising code that when executed on a programmable device forming a primary station causes it to carry out the steps of claim 1.

12. A computer program (25) comprising code that when executed on a computer linked to a primary station causes it to carry out the steps of claim 1.

13. A computer program (25) on a carrier (24) carrying code that when executed on a programmable device forming a primary station causes it to carry out the steps of claim 1.

14. A computer program (25) on a carrier 24 carrying code that when executed on a computer linked to a primary station causes it to carry out the steps of claim 1.
